(19) United States
(12) Patent Application Publication
(10) Pub. No.: US 2014/0323648 A1
(43) Pub. Date: Oct. 30, 2014

(54) PHOTO-INDUCED CROSSLINKING OF DOUBLE BOND-CONTAINING POLYMERS BY MEANS OF A PERICYCLIC REACTION

(71) Applicants: Friedrich Georg Schmidt, Haltern am See (DE); Stefan Hilf, Rodenbach (DE); Christopher Barner-Kowollik, Stutensee (DE); Nathalie Guimard, Saarbruecken (DE); Kim Klaus Oehlenschlaeger, Hockenheim (DE); Jan Mueller, Lorsch (DE)

(72) Inventors: Friedrich Georg Schmidt, Haltern am See (DE); Stefan Hilf, Rodenbach (DE); Christopher Barner-Kowollik, Stutensee (DE); Nathalie Guimard, Saarbruecken (DE); Kim Klaus Oehlenschlaeger, Hockenheim (DE); Jan Mueller, Lorsch (DE)

(73) Assignee: EVONIK INDUSTRIES AG, Essen (DE)

(21) Appl. No.: 14/363,055

(22) PCT Filed: Dec. 14, 2012
(86) PCT No.: PCT/EP2012/075541

§ 371 Date: Jun. 5, 2014

(30) Foreign Application Priority Data
Jan. 10, 2012 (DE) 10 2012 200 235.9

(51) Int. Cl. C08J 3/28; C08F 8/00

(52) U.S. Cl. CPC C08J 3/28; C08F 8/00
USPC 524/558; 525/451; 525/450; 522/130; 524/560

(57) ABSTRACT

The present invention relates to a novel method for photoinduced crosslinking of, for example, adhesives or coating compositions.

More particularly, the present invention relates to a novel, irreversible crosslinking mechanism in which it is possible to obtain, through irradiation with visible light, specific photoactive systems via photoenol reactions controlled high-reactivity diene intermediates which crosslink polymers containing double bonds by means of a Diels-Alder reaction.

### FIELD OF THE INVENTION

The present invention relates to a novel method for photoinduced crosslinking of, for example, adhesives or coating compositions.

More particularly, the present invention relates to a novel, irreversible crosslinking mechanism in which it is possible to obtain, through irradiation with visible light, specific photoactive systems via photoenol reactions controlled high-reactivity diene intermediates which crosslink polymers containing double bonds by means of a Diels-Alder reaction.

### STATE OF THE ART

Methods for photoinduced crosslinking of polymers are of great interest for a broad field of applications. For example, in adhesive applications, various options have been described for the automobile industry or the semiconductor industry. However, such adhesives are also of interest in the construction of machinery or precision equipment, or in the construction industry.

As well as adhesive applications, polymers crosslinkable by photoinduction are also of interest in sealants, coating compositions such as lacquers or paints, or in the production of moldings.

WO 2011/101176 describes the reversible crosslinking of poly(meth)acrylates by means of a hetero-Diels-Alder reaction. However, this reaction can be activated and deactivated only by thermal means. A further disadvantage of such a system, especially for coatings applications, is that thermally reversible crosslinking greatly restricts the service life and the possible uses of such a system.

The coating compositions which are curable by UV irradiation and are detailed in WO 98/033855 have to be cured with very high irradiation energies with exclusion of oxygen. Without these high light energies or in the presence of oxygen, coatings which exhibit low resistance to solvents are frequently obtained. Accordingly, the processibility of these coating compositions is relatively complex.

U.S. Pat. No. 7,829,606 discloses reactive hotmelt adhesives curable by means of radiation. These consist of polyacrylates and long-chain acrylate monomers. The curing is effected in an application-specific manner only with a relatively low crosslinking level. This technology therefore cannot be applied to other applications, for example UV-curable coating materials.

Under the umbrella of “click chemistry”, particularly in academia, there has been research for some years into methods for formation of block copolymers. This involves combining two different homopolymers having bond-forming end groups with one another and joining them to one another, for example by means of a Diels-Alder reaction, Diels-Alder-analogous reaction or another cycloaddition. The aim of this reaction is to form thermally stable, linear and possibly high molecular weight polymer chains.

In Gruendling et al. (Macromolecular Rapid Corn. 2011, 32, p. 807-12), for example, disclose polymethylmethacrylates having a maleimide end group, which are coupled with photoenol compounds for functionalization—for example with OH groups.

Glassner et al. (Macromolecules, 2011, 44, p. 4681-89) describe the synthesis of triblock copolymers by means of the same mechanism as Gruendling et al. This involves coupling PMMA or polystyrene polymers having benzophenone groups at one chain end and cyclopentadiene groups at the other chain end, in each case with maleimide end group-monofunctional PEG or acrylate polymers to give triblock copolymers. This coupling at one chain end is photoinduced, while the coupling at the other chain end having the cyclopentadiene group is thermally induced.

In both methods, the respectively end group-functional polymers have to be prepared in a laborious manner by means of anionic polymerization or, in the case of poly(meth)acrylates, alternatively by means of a controlled free-radical polymerization. In addition, by means of these methods, only mono- or at best bifunctional polymer chains are available. In this way, however, crosslinking reactions are ruled out.

Problem

The problem addressed by the present invention is that of providing a novel photoinducible crosslinking method usable in different applications and within a broad formulation spectrum.

More particularly, the problem is that of providing a photoinducible crosslinking method usable for many polymer systems, especially for poly(meth)acrylates or mixed systems comprising poly(meth)acrylates.

A further problem is that of providing a crosslinking method which is crosslinkable rapidly by means of industrially established UV activation.

An additional problem is that of providing a simple synthesis process for the prepolymers required for the crosslinking reaction.

Further problems which are not stated explicitly are apparent from the overall context of the description, claims and examples which follow.

Solution

The problems have been solved by development of a novel, irreversible crosslinking mechanism usable for various kinds of polymers irrespective of the formulation constituents, such as binders. The mechanism also provides novel crosslinkable formulations. It has been found that, surprisingly, the stated problems can be solved by a formulation crosslinkable by means of a photoinduced Diels-Alder or hetero-Diels-Alder reaction.

The inventive formulations comprise a component A having at least two dienophilic double bonds and a component B having at least two diene group-forming functionalities. Furthermore, the formulation is crosslinkable by means of UV radiation. In addition, at least one of these two components A and B must have more than two, preferably at least three, of the respective functionalities. Moreover, at least one of components A and B is in the form of a polymer. This component having at least three functionalities may be a polymer, and the component having two functionalities may be a low molecular weight substance or an oligomer. In an alternative embodiment, the component having at least three functionalities is an oligomer or a low molecular weight substance, and the component having two functionalities a polymer. In a third, alternative embodiment, both components are polymers. In further alternative embodiments, both components have at least three functionalities, irrespective of which of the two components is a polymer. In a further embodiment, both components are polymers having at least three functionalities.

According to the invention, component B is a compound which forms the diene groups and for this purpose has at least two substituted carbonyl groups of the structure

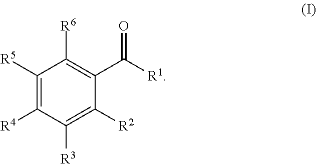

In this formula, R¹ is hydrogen, an aryl group or an alkyl group, preferably hydrogen. R² is a benzyl group or an alkyl group having 1 to 6 carbon atoms, preferably a methyl group, and R³ to R⁶ are identically or each independently hydrogen, ether groups, thioether groups, amine groups, alkoxy groups, alkyl groups or aryl groups, preferably hydrogen or methoxy groups, where one of the groups mentioned may differ by serving as a bridge to the other carbonyl functionalities. More particularly, the carbonyl groups are joined to one another via one of the R³ to R⁶ or R¹ groups. Preferably, the joining is effected via the R⁴ or R⁶ group, more preferably via R⁶. In such a case, this group is preferably bonded by means of an oxygen or sulfur atom, more preferably as an ether, to the aromatic radical of the carbonyl group (I).

Thus, component B, if the bridging is via the R⁶ group, is in a form according to formula (II):

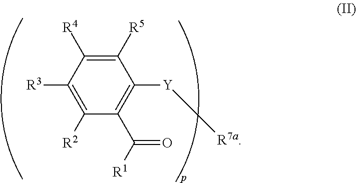

Bridging via another R¹ group or one of the R³ to R⁵ groups would be considered analogously, and bridging via R¹ would be effected via a carbon atom having direct bonding to the carbonyl group. In this embodiment, for example, R¹ could be formed from a correspondingly substituted benzene ring.

Y in the above-specified case, and likewise if the bridging were to be effected via R³ to R⁵, is a sulfur, oxygen or nitrogen atom. R^{7a} is preferably an at least divalent group, which is an aromatic, an alkyl group, a combination of aromatics and alkyl groups, or a polymer or oligomer. p is a number from 2 to 50, preferably a number from 2 to 30. More particularly, the number p for low molecular weight compounds is generally an integer from 2 to 5, preferably 2 or 3.

If R^{7a} is a polymer, p is preferably a number from 2 to 50, preferably from 3 to 30 and more preferably from 5 to 30.

Preferably, component B is a compound of the structure

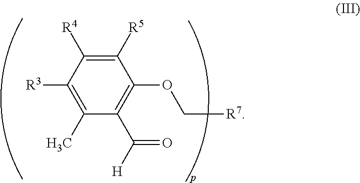

R⁷ here is an at least divalent aryl or alkyl group or a polymer. Preferably, R⁷ is a di- to trivalent aryl group.

Equally preferred is the embodiment in which component B is a polymer having more than 2 carbonyl groups.

Component A is a compound having at least two dienophilic groups. The dienophilic groups have the general structure

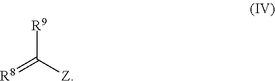

In this formula, Z is an electron-withdrawing group. Known electron-withdrawing groups are CHO, COR¹⁰, COOR¹⁰, COCl, CN, NO₂, CH₂OH, CH₂Cl, CH₂NR¹⁰R¹¹, CH₂CN, CH₂COOH, phenyl, halogen or CR¹⁰═CR¹¹R¹². R¹⁰, R¹¹ and R¹² are each independently hydrogen, alkyl groups or aryl groups.

R⁸ is CR¹²R¹³ or is a sulfur atom. R¹² and R¹³ may each independently be hydrogen, alkyl groups or aryl groups. If R⁸ is a sulfur atom, R⁹ is an SR¹⁰ group. These dithioesters can be used as very active dienophiles in a hetero-Diels-Alder reaction, which in the context of this invention is to be equated to a conventional Diels-Alder reaction.

In a preferred embodiment, the Z group is a 2-pyridyl group, a phosphoryl group or a sulfonyl group. The following are additionally particularly useful: cyano or trifluoromethyl groups, and any other Z group which very greatly reduces the electron density of the R⁸—C double bond and thus allows a rapid Diels-Alder reaction.

Examples of such dithioesters are benzylpyridin-2-yl dithioesters (BPDT, V), 1-phenylethyl diethoxyphosphoryl dithioesters (PDEPDT, VI) and cumyl benzyl dithioesters (CBDT, VII)

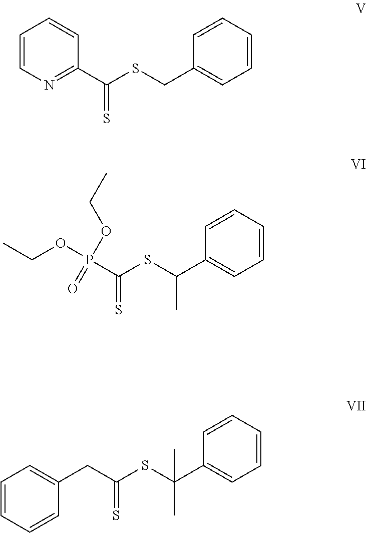 [SMILES: S=C(SCc1ccccc1)c1ccccn1 ; CCOP(=O)(OCC)C(=S)SC(C)c1ccccc1 ; CC(C)(SC(=S)Cc1ccccc1)c1ccccc1]

In addition, R⁹ may be alkyl groups, aryl groups, phosphoryl groups, ether groups, amino groups, or thioether groups. The linkage to the other dienophile groups may be via the R⁸, R⁹ or Z groups, preferably via the R⁹ group. The carriers used for the individual groups may preferably be alkyl or aryl groups, and polymers. Polymers are necessarily involved when component B takes the form of a low molecular weight compound.

Particularly preferred examples of dienophile groups are maleic ester, maleic monoester or maleimide groups (IX):

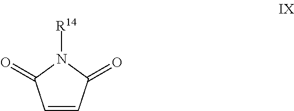

In this formula, R¹⁴ is the group which joins a plurality of the maleimide groups to one another. This is preferably a polymer. By way of example, the maleimide group can be incorporated into a poly(meth)acrylate in the form of a protected monomer. In this regard, the following synthesis route is shown by way of example:

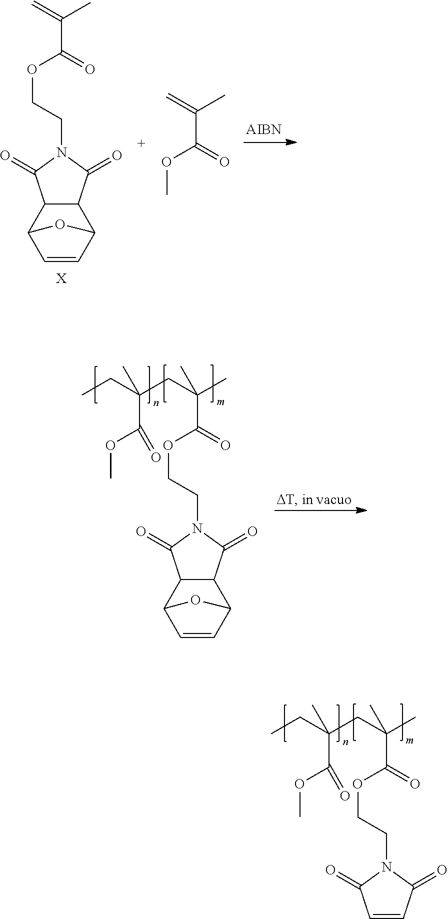

This involves first copolymerizing a protected monomer (X) and then removing the protecting group under reduced pressure.

Especially for polycondensates, such as polyesters, polyamides or polyurethanes, are acrylic groups attached in side groups and/or at the chain ends. Especially acrylic groups are dienophiles of very good suitability. The acrylate groups are equally suitable for polyethers or polybutadienes which have been prepared by means of ionic polymerization. Methacrylic groups are also suitable, although they are less active than acrylic groups. Also particularly suitable are units which are incorporated during a polycondensation or -addition into a polymer chain, for example a polyester. Examples of such units are maleic acid, fumaric acid or itaconic acid, and anhydrides of maleic acid or itaconic acid. In addition, it is also possible to use, for example, vinyl halide groups, vinylbenzyl groups, acrolein groups or cyanoacrylate groups.

Other copolymerizable diene compounds which are commonly used especially for polyolefins, such as EPDM, are and to double bonds which could be suitable with very strong activation by a particularly electron-rich diene and by means of catalysis are 1,4-hexadiene, ethylidenenorbornene or bicyclopentadiene.

In the equally preferred embodiment, the component A used may be a low molecular weight organic compound having at least 2, preferably 2 to 4, dienophile groups, corresponding to the above details. In this embodiment, component B is in the form of a polymer.

If components A and B are each a polymer, these polymers may be different polymers or the same polymers differing only in terms of the functional groups.

The polymers may be polyacrylates, polymethacrylates, polystyrenes, copolymers of acrylates, methacrylates and/or styrenes, polyacrylonitrile, polyethers, polyesters, polylactic acids, polyamides, polyesteramides, polyurethanes, polycarbonates, amorphous or semicrystalline poly-α-olefins, EPDM, EPM, hydrogenated or unhydrogenated polybutadienes, ABS, SBR, polysiloxanes and/or block copolymers, comb copolymers and/or star copolymers of these polymers. These star polymers may have more than 30 arms. The composition of the arms may vary and they may be composed of various polymers. These arms too may in turn have branching sites. The comb polymers may have a block structure and variable comb arms.

The notation “(meth)acrylates” used in the context of this document represents alkyl esters of acrylic acid and/or of methacrylic acid.

The expression “formulation” and all associated percentage figures are based in this case only on components A and B. Further formulation constituents as can be added, for example, in a coating or adhesive composition are not considered in this assessment. Moreover, the expression “formulation” in the context of this document describes exclusively components A and B and an optional crosslinking catalyst. The expression “composition”, in contrast, encompasses not only the formulation but also additionally added components. These additional components may be admixtures selected specifically for the respective application, for example fillers, pigments, additives, compatibilizers, cobinders, plasticizers, impact modifiers, thickeners, defoamers, dispersing additives, rheology improvers, adhesion promoters, scratch-resistant additives, catalysts or stabilizers.

In accordance with the formulation already described, first components A and B and optional further admixtures are combined in the process. Components A and/or B are at least one polymer according to the list given above.

Likewise part of the present invention is the curing process for the inventive formulations. In this process for photoinduced crosslinking, in a first process step, the formulation is produced from at least two different components A and B and optional admixtures, and applied. Subsequently, the formulation is activated by means of UV radiation and then is irreversibly crosslinked spontaneously by means of a Diels-Alder or a hetero-Diels-Alder reaction. The advantage of the present invention is that the formulation is storage-stable over a long period and is easily applicable. The latter arises from the fact that many degrees of freedom are available to the person skilled in the art for the formulation, for example in relation to the viscosity. A further advantage is that the crosslinking itself is effected very rapidly, without release of volatile constituents, and is performable with known apparatus. The crosslinking can be effected by means of any already known crosslinking lamp or UV light source suitable for this purpose. The crosslinking is effected at a wavelength within the absorption range for the carbonyl group of component B for the photoenol reaction. This absorption range can be determined easily by spectroscopic methods. In general, the absorption maximum is between 300 and 400 nm. Thus, crosslinking is generally also effected at a wavelength between 300 and 400 nm.

The crosslinking reaction can be effected at room temperature within 120 min, preferably within 60 min, more preferably within 30 min and most preferably within 10 min.

To support the crosslinking, after the mixing of components A and B, a crosslinking catalyst can be added. However, preference is given to performing the crosslinking without addition of a crosslinking catalyst. To accelerate the crosslinking, the person skilled in the art can preferably increase the radiation dose and/or the concentration of crosslinking-active groups in components A and/or B.

The crosslinking is effected in two steps. In a first step, a dienol is formed from the carbonyl groups of component B by means of UV radiation:

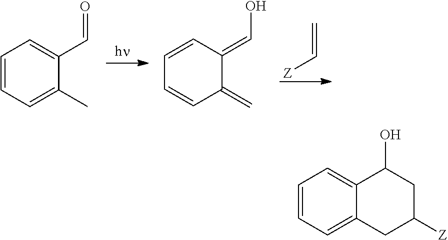

This dienol is a very active, electron-rich diene for a Diels-Alder reaction, which can enter spontaneously into said reaction with the above-described dienophilic groups of component A. Particularly suitable carbonyl groups are compounds XI to XVI. The ether groups on the aromatic ring may preferably constitute the coupling sites to the other photoenol groups of the crosslinker or to the polymer having the other photoenol groups:

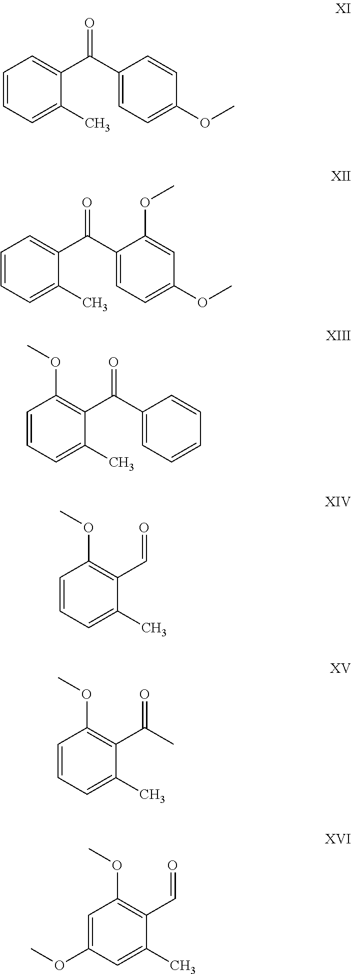

The inventive formulations and processes can be used in a wide variety of different fields of application. The list which follows shows some preferred fields of application by way of example, without restricting the invention in this regard in any way. Such preferred fields of application are adhesives, sealants, molding compounds, lacquers, paint, coatings, composite materials or inks.

Examples from the fields of application of lacquers, coatings and paint are compositions which, for example, can particularly efficiently wet or impregnate porous materials in the unwetted state and give rise to high-coherence materials as a result of the crosslinking reaction.

Similar characteristics are of significance for adhesives which should have a high cohesion and nevertheless are to readily wet the surfaces of the materials to be bonded.

### EXAMPLES

The weight-average molecular weights of the polymers were determined by means of GPC (gel permeation chromatography). The measurements were conducted with a PL-GPC 50 Plus from Polymer Laboratories Inc. at 30° C. in tetrahydrofuran (THF) against a series of polystyrene standards (approx. 200 to 1.10⁶ g/mol).

The NMR analyses were conducted on a Bruker AM 400 MHz spectrometer.

### Example 1

### Synthesis of a Bifunctional Crosslinker XVII with Carbonyl Group XIV

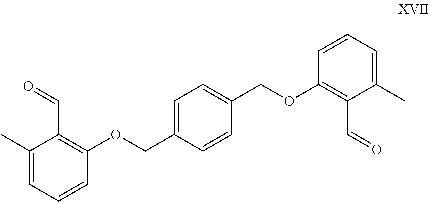

a.) Stage 1: Oxidation of Dimethylanisole

10.0 g of 2,3-dimethylanisole (73.4 mmol, 1 eq), 10.8 g of copper sulfate (73.4 mmol, 1 eq) and 54.4 g of potassium peroxodisulfate (220.2 mmol, 3 eq) were suspended in a round-bottom flask in 400 ml of a mixture of acetonitrile and water (1:1) and refluxed at 100° C. for 30 min. After cooling to room temperature, the insoluble copper salt was removed by means of filtration. The phases were separated in a separating funnel and the aqueous phase was extracted three times with dichloromethane. The combined organic phases were dried over magnesium sulfate and then the solvent was removed under reduced pressure. The remaining crude product was finally purified by means of column chromatography (silica gel, hexanes/ethyl acetate, in a ratio of 5:1). This gave 4.2 g (yield: 40%) of a yellow oil. The product was characterized by means of ¹H NMR.

b) Stage 2: Ether Cleavage

4.2 g of 2-methoxy-6-methylbenzaldehyde from stage 1 (28 mmol, 1 eq) were dissolved in 70 ml of dichloromethane and cooled to 0° C. To this were added 11.2 g of aluminum chloride (83.9 mmol, 3 eq) and the mixture was stirred at room temperature overnight. The mixture was subsequently quenched with water and the two phases formed were separated from one another. The aqueous phase was extracted three times with dichloromethane. The combined organic phases were dried over magnesium sulfate and then the solvent was removed under reduced pressure. The remaining crude product was finally purified by means of column chromatography (silica gel, hexanes/ethyl acetate, in a ratio of 3:1). This gave 3.2 g (yield: 76%) of a yellow solid. The product was characterized by means of ¹H NMR.

c) Stage 3: Ether Formation

0.59 g of 2-hydroxy-6-methylbenzaldehyde from stage 2 (4.33 mmol, 2 eq), 0.572 g of a,a′-dibromo-p-xylene (2.17 mmol, 1 eq) and 0.599 g of potassium carbonate (4.33 mmol, 2 eq) were suspended in 8 ml of DMF and purged with nitrogen for 20 min. Subsequently, the mixture was stirred at 55° C. for 18 h. After cooling to room temperature, the mixture was taken up in 20 ml of dichloromethane and 20 ml of water. The aqueous phase was extracted three times with dichloromethane. The combined organic phases were dried over magnesium sulfate and then the solvent was removed under reduced pressure. This gave 0.8 g (yield: 98%) of a pale yellow solid. The product was characterized by means of ¹H NMR.

### Example 2

### Synthesis of a Maleimide-Functionalized Polymer

a) Stage 1: Maleimide

2.0 g of furan-protected maleic anhydride (12.0 mmol, 1 eq) were dissolved in 50 ml of methanol and cooled to 0° C. To this solution was added dropwise a solution of 0.72 ml of 2-aminoethanol (12.0 mmol, 1 eq) in 20 ml of methanol. Subsequently, the mixture was warmed gradually to room temperature and stirred at room temperature for 30 min. Finally, the solution was stirred under reflux for 4 h before being cooled again to room temperature, and a large portion of the solvent was removed under reduced pressure. The pure product was obtained by recrystallization overnight in methanol. The product was characterized by means of ¹H NMR.

b) Stage 2: Esterification

4.0 g of furan-protected N-(2-hydroxyethyl)maleimide (17.7 mmol, 1.00 eq) and 2.1 ml of triethylamine (21.3 mmol, 1.20 eq) were dissolved in 240 ml of dichloromethane and cooled to 0° C. To this solution were added dropwise 1.82 ml of methacryloyl chloride (18.8 mmol, 1.06 eq) over a period of 30 min. Subsequently, the solution was stirred at 0° C. for a further 2 h. The mixture formed was washed three times each with 60 ml of a saturated NaHSO₄ solution and then with 60 ml of water. The organic phase was dried over magnesium sulfate and the solvent was removed under reduced pressure. The remaining crude product was finally purified by means of column chromatography (silica gel, hexanes/ethyl acetate, in a ratio of 1:1). This gave 1.5 g (yield: 38%) of a white solid. The product was characterized by means of ¹H NMR.

c) Stage 3: Polymerization

To a solution of 1.5 g of the furan-protected monomer from stage 2 (5.41 mmol, 1 eq) and 1.08 g of methyl methacrylate (MMA, 10.82 mmol, 2 eq) in 35 ml of dried tetrahydrofuran (THF) were added 88.8 mg of 2,2′-azobisisobutyronitrile (AIBN, 0.54 mmol, 0.1 eq). The mixture was purged with nitrogen for 20 min and then heated to 65° C. After 7.5 h, the solvent was removed under reduced pressure and the residue was taken up in small amounts of dichloromethane. Finally, the polymer was precipitated in cold methanol, filtered off and dried. Yield: 1.5 g (58%). Product characterization was effected by means of ¹H NMR.

d) Stage 4: Removing the Protecting Groups

500 g of the copolymer from stage 3 were heated to 125° C. under reduced pressure for 6 h. Product characterization was effected by means of ¹H NMR.

### Example 3

### Crosslinking Reaction of the Polymer from Example 2

1 mg of the crosslinker from example 1 (2.67 mmol, 2.14 eq) and 5 mg of the maleimide-functionalized polymer from example 2 (1.25 mmol, 1.00 eq) are weighed into headspace vials (Pyrex, diameter 20 mm) and dissolved in dichloromethane. The vials were then sealed airtight with a styrene/butadiene rubber seal having an inner PTFE coating. The sample was irradiated by means of a low-pressure fluorescence lamp (Arimed B6, Cosmedico GmbH, Stuttgart, Germany) having a wavelength of 320 nm (±30 nm) from a distance between 40 and 50 mm in a photoreactor over a period of 60 min. After the reaction, the solvent was removed under reduced pressure. The solid obtained was insoluble in dichloromethane and hence crosslinked.

### Example 4

### Synthesis of a Maleic Monoester-Functionalized Polymer

For synthesis of a maleic monoester-functionalized polymer based on methacrylates, a copolymer of hydroxyethyl methacrylate (HEMA) with further comonomers was prepared by processes known to those skilled in the art. The polymer was dissolved in a suitable and anhydrous solvent so as to form a readily stirrable polymer solution (for example ethyl acetate), and one mole equivalent of maleic anhydride (calculated based on the HEMA components present) and 0.1 equivalent of triethylamine were added, and then the mixture was stirred at 60° C. for four hours. The polymer obtained was precipitated in cold hexane, filtered off and dried under reduced pressure (polymer 585). The degree of conversion is determined by ¹H NMR.

### Example 5

### Crosslinking Reaction of the Polymer from Example 4

100 mg of polymer (13.9 mmol, 1.00 eq) from example 4 and 25 mg of crosslinker from example 1 (66.8 mmol, 4.81 eq) are weighed into headspace vials (Pyrex, diameter 20 mm) and dissolved in dichloromethane. The vials were then sealed airtight with a styrene/butadiene rubber seal having an inner PTFE coating. The sample was irradiated by means of a low-pressure fluorescence lamp (Arimed B6, Cosmedico GmbH, Stuttgart, Germany) having a wavelength of 320 nm (±30 nm) from a distance between 40 and 50 mm in a photoreactor over a period of 24 h. The solid obtained was no longer soluble and hence crosslinked.

1. A formulation, comprising:
a component A comprising at least two dienophilic double bonds, and
a component B comprising at least two carbonyl groups of structure (I) 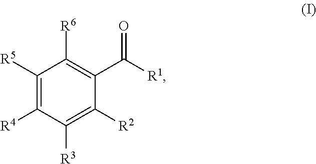
where R¹ is hydrogen or an alkyl group, R² is a benzyl group or an alkyl group comprising 1 to 6 carbon atoms, and R³ to R⁶ are each independently hydrogen, an ether group, a thioether group, an amine group, an alkoxy group, an alkyl group or an aryl group,
wherein
each individual structure (I) is joined to one another via one of the R³ to R⁶ or R¹ groups,
at least one of the component A and the component B has more than two functionalities,
at least one of the component A and the component B is a polymer,
and the formulation is crosslinkable via UV radiation.

2. The formulation of claim 1, wherein R¹ is hydrogen, R² is a methyl group, R³ to R⁵ are each independently hydrogen, or a methoxy group, and R⁶ is an ether or a thioether group via which at least two of the carbonyl groups are joined to one another.

3. The formulation of claim 1, wherein the component B is a compound of structure (II) 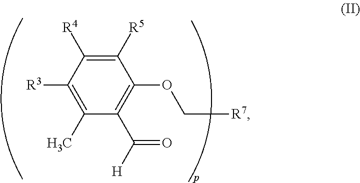
where R⁷ is an at least divalent aryl or alkyl group or a polymer, and p is a number of from 2 to 30.

4. The formulation of claim 1, wherein the component B is a low molecular weight organic compound comprising 2 to 3 of the carbonyl groups.

5. The formulation of claim 1, wherein the component B is a polymer comprising more than 2 of the carbonyl groups.

6. The formulation of claim 4, wherein the component A is a polymer comprising at least three acrylate groups, methacrylate groups, vinyl halide groups, vinylbenzyl groups, acrolein groups, cyanoacrylate groups, maleimide groups, dithioesters, or groups obtained by copolymerization of maleic acid, furanic acid or itaconic acid, as dienophilic groups.

7. The formulation of claim 5, wherein the component A is a low molecular weight compound comprising at least two dienophilic groups.

8. The formulation of claim 1, wherein the polymer is a polyacrylate, polymethacrylate, polystyrene, a copolymer of acrylates, methacrylates and/or styrenes, polyacrylonitrile, a polyether, a polyester, polylactic acid, a polyamide, a polyesteramide, a polyurethane, polycarbonate, an amorphous or a semicrystalline poly-α-olefin, EPDM, EPM, a hydrogenated or an unhydrogenated polybutadiene, ABS, SBR, a polysiloxane, or a block copolymer, a comb copolymer or a star copolymer thereof.

9. A process for photoinduced crosslinking, comprising:
activating the formulation of claim 1 via UV radiation having a wavelength between 300 and 400 nm, and
then irreversibly and spontaneously crosslinking via a Diels-Alder or a hetero-Diels-Alder reaction.

10. A composition, comprising the formulation of claim 1,
wherein the composition is an adhesive, a sealant, a molding compound, a lacquer, paint, a coating, ink or a composite material.
